(19) United States
(12) Patent Application Publication
(10) Pub. No.: US 2025/0112334 A1
(43) Pub. Date: Apr. 3, 2025

(54) BUSBAR APPARATUS

(71) Applicant: Rivian IP Holdings, LLC, Irvine, CA (US)

(72) Inventors: Andrew Robert Krasts, San Clemente, CA (US); Pierluigi Leccese, Irvine, CA (US); Jonathan Christopher Wilson, Rancho Mission Viejo, CA (US); Ryan Michael Norris, Mission Viejo, CA (US); Casey Taylor Dunn, Mission Viejo, CA (US)

(21) Appl. No.: 18/478,300

(22) Filed: Sep. 29, 2023

(51) Int. Cl. H01M 50/503; H01M 50/517

(52) U.S. Cl. CPC H01M 50/503; H01M 50/517; H01M 2220/20

(57) ABSTRACT

An apparatus can include an interface member that can couple with a first busbar of a first header of a battery pack. The interface member can couple with a second busbar of a second header of the battery pack.

### INTRODUCTION

A variety of systems can include one or more connectors to facilitate coupling electrical components together. For example, a connector can couple with a header on an enclosure of a battery pack.

### SUMMARY

Generally, electrical headers (e.g., connectors) can include one or more busbars. Systems and methods described herein can provide an interface that integrates a positive busbar and a negative busbar that each can connect with multiple headers. For example, the systems and methods described herein are directed to an interface (e.g., an insulating plate, plug, or other interface) that encloses a unitary positive busbar and a unitary negative busbar. Each of the negative busbar and the positive busbar can couple with multiple headers through the interface. For example, the interface can couple with a first header (e.g., a front drive unit header) and a second header (e.g., a rear drive unit header). The disclosed solutions have various technical advantages. For example, integrating two distinct busbars into one interface (e.g., a plate, plug, or other interface) to couple with multiple headers (e.g., a first header and a second header) can facilitate reducing the amount of parts and joints that connect the front drive unit connections with the battery pack and the rear drive unit connections with the battery pack. Additionally, by fixing the first header relative to the second header by the interface, the interface improves tolerance stack ups by reducing the variability in positioning of the headers.

At least one aspect is directed to an apparatus. The apparatus can include an interface member that can couple with a first busbar of a first header of a battery pack. The interface member can couple with a second busbar of a second header of the battery pack. At least one aspect is directed to a method. The method can include coupling a first busbar of a first header of a battery pack with an interface member. The method can include coupling a second busbar of a second header of the battery pack with the interface member.

At least one aspect is directed to an electric vehicle. The electric vehicle can include an interface member that can couple with a first busbar of a first header of a battery pack. The interface member can couple with a second busbar of a second header of the battery pack.

At least one aspect is directed to a method. The method can include providing an apparatus. The apparatus can include an interface member that can couple with a first busbar of a first header of a battery pack. The interface member can couple with a second busbar of a second header of the battery pack.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification. The foregoing information and the following detailed description and drawings include illustrative examples and should not be considered as limiting.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 depicts an example electric vehicle, in accordance with implementations.

FIG. 2 depicts an example battery pack, in accordance with implementations.

FIG. 3 depicts a perspective view of an example battery pack of FIG. 2, in accordance with implementations.

FIG. 4 depicts a perspective view of a portion of the battery pack of FIG. 3, in accordance with implementations.

FIG. 5 depicts a rear perspective view of an apparatus of the battery pack of FIG. 3, in accordance with implementations.

FIG. 6 depicts a front perspective view of the apparatus of FIG. 5, in accordance with implementations.

FIG. 7 depicts a front perspective view of the apparatus of FIG. 5 with a portion of the apparatus being transparent, in accordance with implementations.

FIG. 8 depicts a cross sectional view of a portion of the apparatus of FIG. 5 coupled with the battery pack of FIG. 3, in accordance with implementations.

FIG. 9 depicts a front view of a portion of the battery pack of FIG. 3, in accordance with implementations.

FIG. 10 depicts an example illustration of a process, in accordance with implementations.

FIG. 11 depicts an example illustration of a process, in accordance with implementations.

### DETAILED DESCRIPTION

Following below are more detailed descriptions of various concepts related to, and implementations of, methods, apparatuses, and systems of a busbar interface. The various concepts introduced above and discussed in greater detail below may be implemented in any of numerous ways.

The present disclosure is directed to systems and methods of providing an interface that integrates a positive busbar and a negative busbar that each can connect with multiple headers. For example, the systems and methods described herein are directed to an interface (e.g., insulating plate, plug, or other interface) that encloses a unitary positive busbar and a unitary negative busbar. Each of the negative busbar and the positive busbar can couple with multiple headers through the interface. For example, the interface can couple with a first header (e.g., a front drive unit header) and a second header (e.g., a rear drive unit header). Each of the positive busbar and the negative busbar can couple with a portion of a battery pack. For example, the negative busbar in connection with both the first and second header can couple with a portion of the battery pack by a first fastener and the positive busbar in connection with both the first and second header can couple with a portion of the battery pack by a second fastener.

The disclosed solutions have various technical advantages. For example, integrating two distinct busbars into one interface (e.g., a plate, plug, or other interface) to couple with multiple headers (e.g., a first header and a second header) can facilitate reducing the amount of parts that connect the front drive unit connections with the battery pack and the rear drive unit connections with the battery pack. For example, conventional techniques include at least two busbars for the front drive unit and at least two busbars for the rear drive unit. By integrating a positive busbar that can connect with both the front drive unit header and the second drive unit header and a negative busbar that can connect with both the front drive unit header and the second drive unit header, the interface reduces the amount of busbars within the battery pack. Additionally, integrating two distinct busbars into one interface (e.g., a plate, plug, or other interface) to couple with multiple headers (e.g., a first header and a second header) can facilitate reducing the amount of joints that connect the busbars with at least a portion of the battery pack. For example, conventional techniques include at least four fasteners to couple the at least four busbars of the front and rear drive unit connections. By integrating the positive and negative busbar into one interface, the positive busbar can include one joint (e.g., fastener) and the negative busbar can include one joint (e.g., fastener) to reduce the amount of joints from four to two. Furthermore, by fixing the first header relative to the second header by the interface, the interface improves tolerance stack ups by reducing the variability in positioning of the headers.

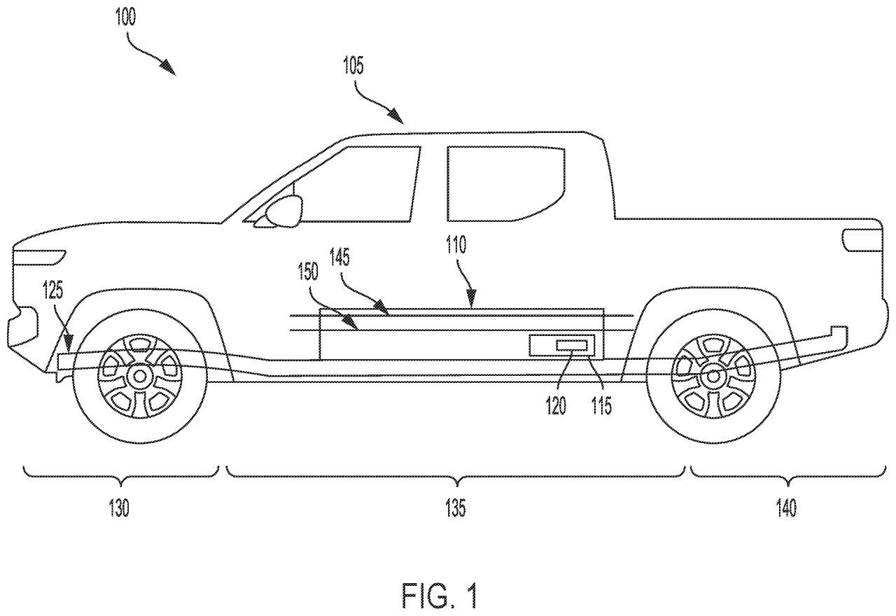

FIG. 1 depicts an example cross-sectional view 100 of an electric vehicle 105 installed with at least one battery pack 110. Electric vehicles 105 can include electric trucks, electric sport utility vehicles (SUVs), electric delivery vans, electric automobiles, electric cars, electric motorcycles, electric scooters, electric passenger vehicles, electric passenger or commercial trucks, hybrid vehicles, or other vehicles such as sea or air transport vehicles, planes, helicopters, submarines, boats, or drones, among other possibilities. The battery pack 110 can also be used as an energy storage system to power a building, such as a residential home or commercial building. Electric vehicles 105 can be fully electric or partially electric (e.g., plug-in hybrid) and further, electric vehicles 105 can be fully autonomous, partially autonomous, or unmanned. Electric vehicles 105 can also be human operated or non-autonomous. Electric vehicles 105 such as electric trucks or automobiles can include on-board battery packs 110, batteries 115 or battery modules 115, or battery cells 120 to power the electric vehicles. The electric vehicle 105 can include a chassis 125 (e.g., a frame, internal frame, or support structure). The chassis 125 can support various components of the electric vehicle 105. The chassis 125 can span a front portion 130 (e.g., a hood or bonnet portion), a body portion 135, and a rear portion 140 (e.g., a trunk, payload, or boot portion) of the electric vehicle 105. The battery pack 110 can be installed or placed within the electric vehicle 105. For example, the battery pack 110 can be installed on the chassis 125 of the electric vehicle 105 within one or more of the front portion 130, the body portion 135, or the rear portion 140. The battery pack 110 can include or connect with at least one busbar, e.g., a current collector element. For example, the first busbar 145 and the second busbar 150 can include electrically conductive material to connect or otherwise electrically couple the battery 115, the battery modules 115, or the battery cells 120 with other electrical components of the electric vehicle 105 to provide electrical power to various systems or components of the electric vehicle 105.

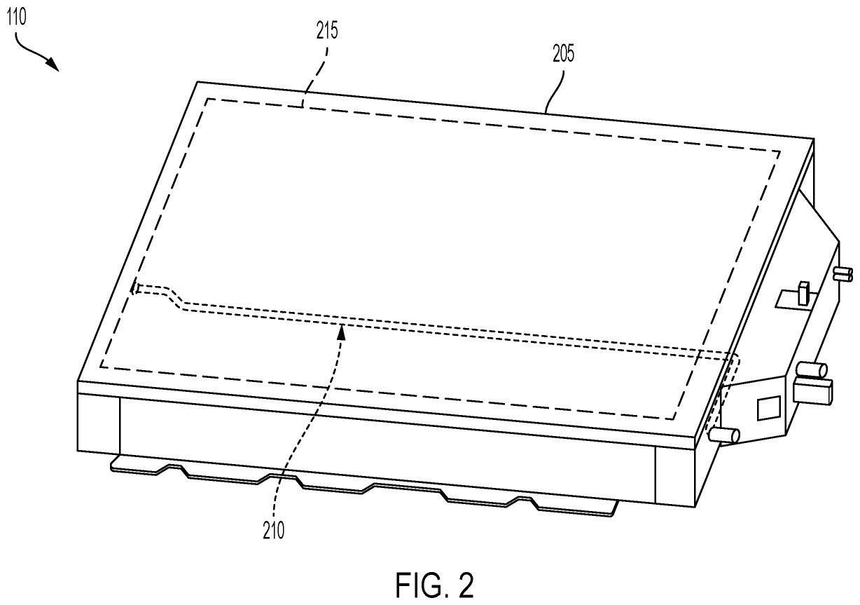

FIG. 2 depicts an example battery pack 110. Referring to FIG. 2, among others, the battery pack 110 can provide power to electric vehicle 105. Battery packs 110 can include any arrangement or network of electrical, electronic, mechanical or electromechanical devices to power a vehicle of any type, such as the electric vehicle 105. The battery pack 110 can include at least one housing 205. The housing 205 can include at least one battery module 115 or at least one battery cell 120, as well as other battery pack components. The battery module 115 can be or can include one or more groups of prismatic cells, cylindrical cells, pouch cells, or other form factors of battery cells 120. The housing 205 can include a shield on the bottom or underneath the battery module 115 to protect the battery module 115 and/or cells 120 from external conditions, for example if the electric vehicle 105 is driven over rough terrains (e.g., off-road, trenches, rocks, etc.) The battery pack 110 can include at least one cooling line 210 that can distribute fluid through the battery pack 110 as part of a thermal/temperature control or heat exchange system that can also include at least one thermal component (e.g., cold plate) 215. The thermal component 215 can be positioned in relation to a top submodule and a bottom submodule, such as in between the top and bottom submodules, among other possibilities. The battery pack 110 can include any number of thermal components 215. For example, there can be one or more thermal components 215 per battery pack 110, or per battery module 115. At least one cooling line 210 can be coupled with, part of, or independent from the thermal component 215.

The battery modules 115 can each include a plurality of battery cells 120. The battery modules 115 can be disposed within the housing 205 of the battery pack 110. The battery modules 115 can include battery cells 120 that are cylindrical cells or prismatic cells, for example. The battery module 115 can operate as a modular unit of battery cells 120. For example, a battery module 115 can collect current or electrical power from the battery cells 120 that are included in the battery module 115 and can provide the current or electrical power as output from the battery pack 110. The battery pack 110 can include any number of battery modules 115. For example, the battery pack can have one, two, three, four, five, six, seven, eight, nine, ten, eleven, twelve or other number of battery modules 115 disposed in the housing 205. It should also be noted that each battery module 115 may include a top submodule and a bottom submodule, possibly with a thermal component 215 in between the top submodule and the bottom submodule. The battery pack 110 can include or define a plurality of areas for positioning of the battery module 115 and/or cells 120. The battery modules 115 can be square, rectangular, circular, triangular, symmetrical, or asymmetrical. In some examples, battery modules 115 may be different shapes, such that some battery modules 115 are rectangular but other battery modules 115 are square shaped, among other possibilities. The battery module 115 can include or define a plurality of slots, holders, or containers for a plurality of battery cells 120. It should be noted the illustrations and descriptions herein are provided for example purposes and should not be interpreted as limiting. For example, the battery cells 120 can be inserted in the battery pack 110 without battery modules and. The battery cells 120 can be disposed in the battery pack 110 in a cell-to-pack configuration without modules and, among other possibilities. Battery cells 120 have a variety of form factors, shapes, or sizes. For example, battery cells 120 can have a cylindrical, rectangular, square, cubic, flat, pouch, elongated or prismatic form factor.

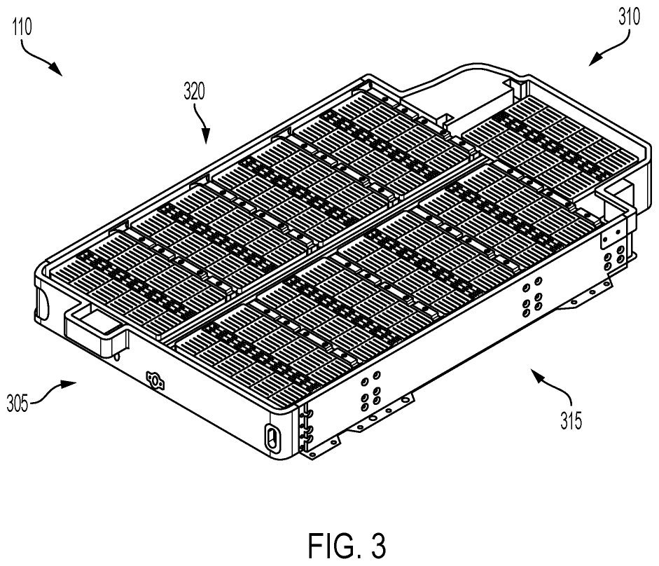

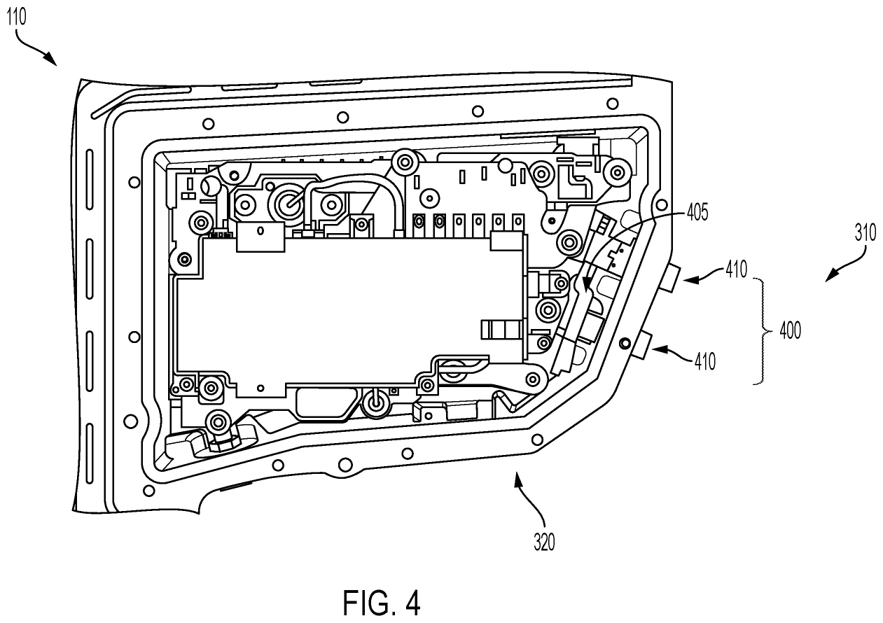

FIG. 3 depicts a perspective top view of an example battery back 110. The battery pack 110 can extend from a first end 305 towards a second end 310 in a longitudinal direction, and from a first side 315 to a second side 320 in a lateral direction. FIG. 4 depicts a top view of a portion of the battery pack 110. For example, FIG. 4 depicts a corner portion of the battery pack 110 at, for example, the corner of the second end 310 and the second side 320. As depicted in FIG. 4, among others, the battery pack 110 can include at least one header 410 that couples with an external portion (e.g., housing 205 depicted in at least FIG. 2) of the battery pack 110. The one or more headers 410 can be positioned at a corner portion of the battery pack 110 (e.g., as depicted in at least FIG. 4), or at various other portions of the battery pack 110 along the housing 205 of the battery pack 110. For example, the one or more headers 410 can be positioned along a front or back of the battery pack 110 (e.g., at or near the first end 305 or the second end 310) or along a side of the battery pack 110 (e.g., at or near the first side 315 or the second side 320).

The header 410 can be or can include one or more connectors, plugs, or receptacles capable of coupling one or more components (e.g., cables, busbars, or other components) with a high voltage (“HV”) or high electrical interference system. The header 410 can facilitate coupling one or more electrical components of the vehicle 105 (e.g., a drive unit (e.g., a front drive unit or a rear drive unit), an inverter, a motor, an air conditioning unit, a heater, an AC charger, or other electrical components) with one or more components of the battery pack 110 (e.g., a battery management system (“BMS”), the battery cells, or another component) such that electrical current or signals can flow between a component of the battery pack 110 and one or more electrical components of the vehicle 105 disposed outside of the battery pack housing 205. For example, the header 410 can couple with a portion of the housing 205 of the battery pack 110 such that at least a portion of the header 410 is exposed to an area exterior to the battery pack housing 205, as shown in at least FIG. 4. The header 410 can include or can couple with one or more portions interior to the battery pack housing 205 (e.g., the header 410 can extend within an internal portion of the battery pack housing 205). The header 410 can couple with various other systems or appliances. For example, the header 410 can couple one or more electrical components with an inverter, a compressor (e.g., an alternating current “AC” compressor), a heater, or another device. As an example, the header 410 can couple with any device that uses a shielded cable or enclosure (e.g., an electrical cable enclosed by one or more insulated layers, a component having a faraday shield, a component having a coated exterior, or another component).

The header 410 can include one or more non-metallic materials that form the header 410. For example, the header 410 can be formed from one or more materials including, but not limited to, plastics (e.g., polyamide, nylon, polyamide 66 (“PA66”), polymer, polybutylene terephthalate (“PBT”), acrylonitrile butadiene styrene (“ABS”), polycarbonate (“PC”), polyethylene (“PE”), polypropylene (“PP”), polyethylene terephthalate (“PETE”), polyvinyl chloride (“PVC”), or other plastics), or other non-metallic materials. The header 410 can be formed in a variety of ways including, but not limited to, molding (e.g., injection molding, compression molding, or other forms of molding), extrusion, subtractive manufacturing, additive manufacturing (e.g., 3D printing), or other types of manufacturing.

The battery pack 110 can include a plurality of headers 410. For example, an apparatus 400 of the battery pack 110 can include an interface member 405, depicted throughout the figures, that couples with a first header 410 (e.g., a header 410 that couples with front drive electrical units) and a second header 410 (e.g., a header 410 that couples with rear drive electrical units).

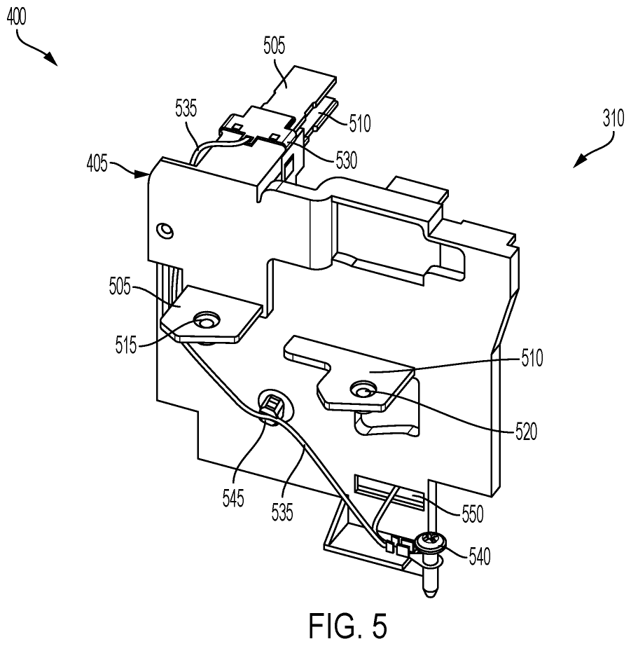

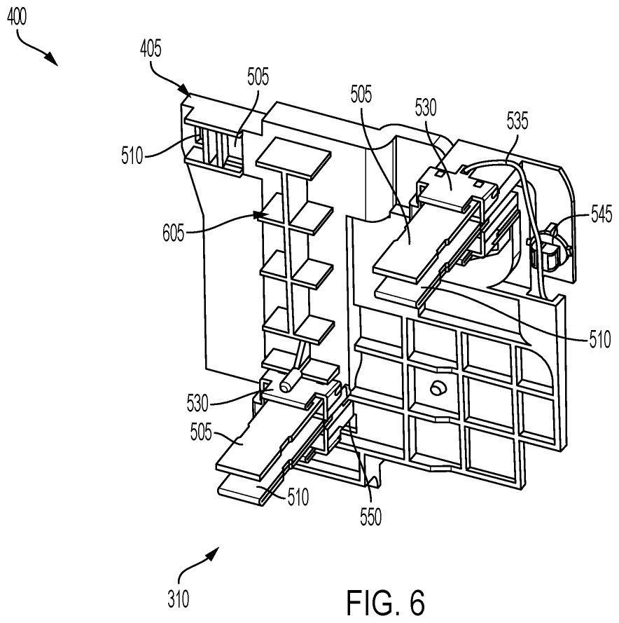

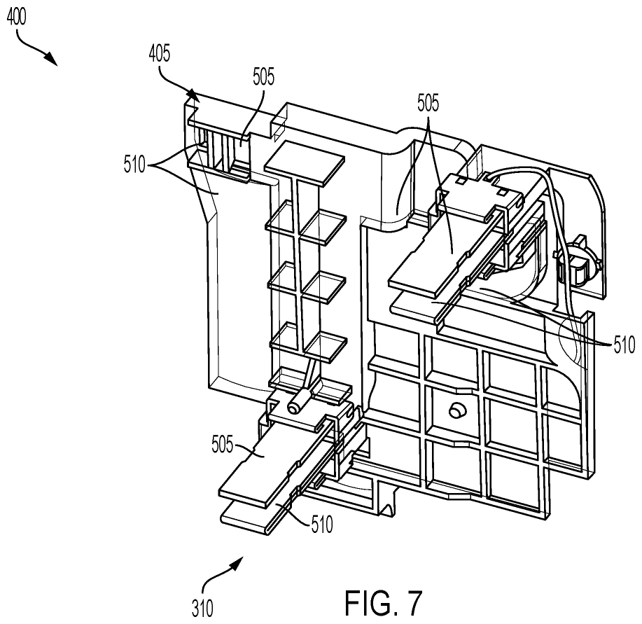

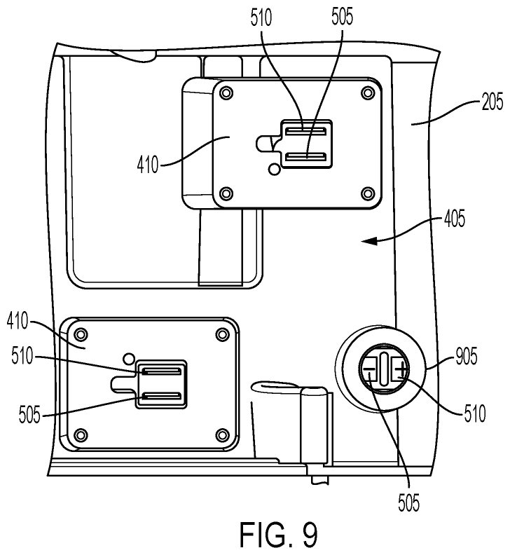

FIG. 5 depicts a perspective view of the apparatus 400. FIG. 5 depicts a rear perspective view of the apparatus 400. In other words, FIG. 5 depicts a side of the apparatus 400 that faces an interior of the battery pack 110 (e.g., a side of the interface member 405 that faces the first end 305 of the battery pack 110). FIG. 6 depicts a front perspective view of the apparatus 400. In other words, FIG. 6 depicts a side of the apparatus 400 that faces the second end 310 of the battery pack 110 (e.g., a side of the interface member 405 that faces the second end 310). For example, as depicted in FIGS. 5 and 6, among others (e.g., FIG. 9), a portion of the apparatus 400 (e.g., the busbars 505, 510 described herein) extend from a portion of the apparatus 400 to an external portion of the battery pack 110 at the second end 310 of the battery pack 110. FIG. 7 depicts a front perspective view of the apparatus with portions of the interface member 405 of the apparatus 400 being transparent.

As shown in FIGS. 5-7, among others, the apparatus 400 can include the interface member 405. The interface member 405 can be or can include a piece of material that couples with or joins a first header 410 and a second header 410. The interface member 405 can be an insulator, plug, plate, or other interface. For example, the interface member 405 can be formed of one or more insulative materials including, but not limited to, plastic. The interface member 405 can be unitary (e.g., continuous, monolithic), or the interface member 405 can include two or more separate pieces coupled together. The interface member 405 can couple with the first header 410 and the second header 410 such that the first header 410 and the second header 410 are rigidly fixed relative to one another (e.g., such that the headers 410 and the interface member 405 are all connected).

The interface member 405 can couple with a first busbar 505 of the first header 410 and with a second busbar 510 of the second header 410. The first busbar 505 and the second busbar 510 can be independent of one another (e.g., two separately formed busbars). For example, the first busbar 505 can be a negative connection busbar and the second busbar 510 can be a positive connection busbar.

The interface member 405 can couple with the first busbar 505 and the second busbar 510 in various ways. For example, as depicted in at least FIG. 7, the interface member 405 can be overmolded onto a portion of the first busbar 505 or a portion of the second busbar 510 such that the interface member 405 at least partially surrounds or encloses the first busbar 505 and the second busbar 510. At least a portion of the first busbar 505 can protrude or extend from the interface member 405 (e.g., such that the first busbar 505 can couple with the first header 410 or receive a fastener, as described herein) and at least a portion of the second busbar 510 can protrude or extend from the interface member 405 (e.g., such that the second busbar 510 can couple with the second header 410 or receive a fastener, as described herein).

The first busbar 505 can include or can be a negative busbar for a front drive unit and a rear drive unit of the vehicle 105. In other words, the first busbar 505 can be one, unitary negative busbar that connects with both the front drive unit header 410 and the rear drive unit header 410. The second busbar 510 can include or can be a positive busbar for a front drive unit and a rear drive unit of the vehicle 105. In other words, the second busbar 510 can be one, unitary positive busbar that connects with both the front drive unit header 410 and the rear drive unit header 410. With this configuration, the apparatus 400 improves conventional technology in that one unitary interface (e.g., the interface member 405) can include one negative busbar 505 and one positive busbar 510 for each of the front drive unit electrical connections and the rear drive unit electrical connections as opposed to having four individual busbars (e.g., a positive and negative busbar for only the front drive unit and a positive and negative busbar for only the rear drive unit). This overmolded interface facilitates reducing part count by combining the busbars into one interface and improves tolerance stacks by fixing the location of the multiple headers 410 relative to one another.

The interface member 405 can house (e.g., enclose, surround) each of the first busbar 505 and the second busbar 510. The interface member 405 can insulate the first busbar 505 from the second busbar 510 while allowing each of the first busbar 505 and the second busbar 510 to couple with the first header 410 and the second header 410. The first busbar 505 can form a first shape, the second busbar 510 can form a second shape, where each of the first and second shapes oppose and interface with one another. For example, the interface member 405 can split the first busbar 505 and the second busbar 510 into two “Y” or “U” shaped features within the interface member 405. For example, the first busbar 505 and the second busbar 510 can form generally “U” shapes that oppose and partially interface one another such that the first busbar 505 can extend from the first header 410 to the second header 410 and the second busbar 510 can extend from the first header 410 to the second header 410 while keeping the first busbar 505 separate from or insulated the second busbar 510.

At least a portion of the first busbar 505 can receive a first fastener 515 to connect the first busbar 505 to the battery pack 110 (e.g., with a high-voltage distribution box (HVDB)). At least a portion of the second busbar 510 can receive a second fastener 520 to connect the second busbar 510 to the battery pack 110 (e.g., with the HVDB). With this configuration, the apparatus 400 improves conventional technology in that one interface (e.g., interface member 405) can couple one negative busbar 505 and one positive busbar 510 for each of the front drive unit electrical connections and the rear drive unit electrical connections with two respective fasteners 515, 520 as opposed to having more than two fasteners. Thus, providing an interface (e.g., interface member 405) that couples with multiple headers 410 enables two busbar connections as opposed to four (e.g., one fastener for a positive busbar of the front drive unit, one fastener for a negative busbar of the front drive unit, one fastener for a positive busbar of the rear drive unit, and one fastener for a negative busbar of the rear drive unit).

The interface member 405 can include one or more openings or windows (e.g., portions of the interface member 405 that do not cover the busbars) such that at least one of the first busbar 505 or the second busbar 510 is exposed outside of the interface member 405 with or without protruding from the interface member 405. For example, the windows can allow the electrical connection of the busbars 505, 510 to be tested (e.g., by using an electrical tester, voltage probe, or other multimeter) even with the interface member 405 insulating the busbars 505, 510.

The apparatus 400 can include at least one first clip 530 to facilitate electrically coupling the first header 410 with the battery pack 110 and at least one second clip 530 to facilitate electrically coupling the second header 410 with the battery pack 110. For example, the first header 410 can couple with a first clip 530 (e.g., by at least partially engaging the clip 530) and the second header 410 can couple with a second clip 530 (e.g., by at least partially engaging the clip 530). The one or more clips 530 can be formed of a conductive material and can at least partially contact one or more of the first busbar 505 or the second busbar 510. The one or more clips 530 can contact at least one conductive pathway (e.g., line 535). For example, the conductive line 535 can be or include a wire, cable, or other line formed of a conductive material. The line 535 can couple with the clip 530 in various ways including, but not limited to, welding, fasteners, conductive adhesives, or other means. For example, the line 535 can be a ground neutral (GND) wire or overmolded ground busbar that connects to the corresponding header 410.

The line 535 can couple with a fastener 540 (e.g., via welding or other means) such that the line 535 at least partially contacts the fastener 540. The fastener 540 can be or include a cutting fastener (e.g., screw), bolt, clip, tab, clamp, or other feature that can couple with a portion of the battery pack 110. The fastener 540 can include at least one conductive material. The fastener 540 can include at least one sharp portion or end (e.g., point, threads, etc.) that can extend through, cut away, or pierce a non-conductive coating of the housing 205 of the battery pack 110 to facilitate forming a conductive pathway. For example, the fastener 540 can be a thread forming or E-coat clearing fastener. For example, the conductive pathway can extend from the header 410, to the clip 530 or to a busbar 505, to the line 535, to the fastener 540, to the housing 205 of the battery pack 110. In other words, the first busbar 505 and the second busbar 510 can electrically couple with the battery pack 110 (e.g., be grounded) by the grounding wire line 535.

The interface member 405 can include at least one opening 550. For example, the opening 550 can be a through-hole (e.g., extending both through the interface member 405 and through or around the first busbar 505 or second busbar 510) such that a portion of a line 535 or wire can extend through the opening 550. With this configuration, the line 535, for example, the line 535 coupled with the second header 410, can extend through the opening 550 to couple with the fastener 540. For example, the first header 410 can couple with a first line 535 and the second header 410 can couple with a second line 535. The opening 550 can allow each of the first line 535 and the second line 535 to couple with one fastener 540.

The interface member 405 can include at least one clasp 545 that can facilitate keeping a line 535 close to the interface member 405. For example, the clasp 545 can couple with at least a portion of a line 535 to couple the line 535 with the interface member 405. The clasp 545 can be formed of the same material as the interface member 405 (e.g., a non-conductive or insulative material), or the clasp 545 can be formed of a different material.

The interface member 405 can include at least one rib 605. The one or more ribs 605 can facilitate preventing rotation of the interface member 405 relative to the battery pack 110. For example, the ribs 605 can provide additional strength to the interface member 405 (as compared to the interface member 405 just being planar). The ribs 605 can facilitate reducing flexing of the interface member 405. The ribs 605 can extend or protrude from a surface of the interface member 405 such that the ribs 605 can engage or contact another portion of the battery pack 110 (e.g., the battery pack housing 205) to facilitate maintaining the interface member 405 in position relative to the housing 205 and reducing rotation of the interface member 405 relative to the housing 205.

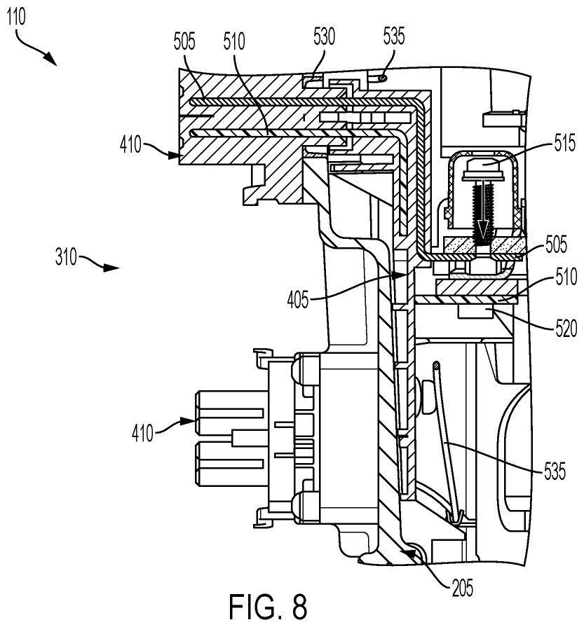

FIG. 8 depicts a cross-sectional view of a portion of the battery pack 110. As described herein and depicted in at least FIG. 8, the first busbar 505 can include a unitary negative busbar that extends throughout the overmolded interface member 405 at least partially within a first header 410 (e.g., a front drive unit header 410), at least partially within the second header 410 (e.g., a rear drive unit header 410), and at least partially internally within the battery pack housing 205 to couple with a fastener 515. The second busbar 510 can include a unitary positive busbar that extends throughout the overmolded interface member 405 at least partially within a first header 410 (e.g., a front drive unit header 410), at least partially within the second header 410 (e.g., a rear drive unit header 410), and at least partially internally within the battery pack housing 205 to couple with a fastener 520.

FIG. 9 depicts a front view of an external portion of the battery pack housing 205 with the first busbar 505 and the second busbar 510 at least partially exposed for servicing. For example, the first busbar 505 and the second busbar 510 can be exposed externally in at least one section of the interface member 405 such that the positioning of the first busbar 505 and the second busbar 510 can be located for servicing. For example, as described herein, the interface member 405 can include at least one window that exposes the first busbar 505 and the second busbar 510 to an external portion of the interface member 405. The battery pack housing 205 can include at least one service port 905 that can be separate from the headers 410 such that the first busbar 505 and the second busbar 510 can be tested or otherwise accessed from the external portion of the battery pack housing 205 when the apparatus 400 is installed in the battery pack 110.

The apparatus 400 can include various sizes or shapes. For example, as depicted throughout the figures, the interface member 405 can include a partially square shape. The interface member 405 and busbars 505, 510 can extend various dimensions including approximately 100-150 mm wide, 125-175 mm tall, and 75-125 mm deep. These dimensions are for illustrative purposes. The apparatus 400 can be substantially smaller or larger (e.g., 50 mm wide, 50 mm tall, and 50 mm deep, 500 mm wide, 500 mm tall, and 500 mm deep, etc.).

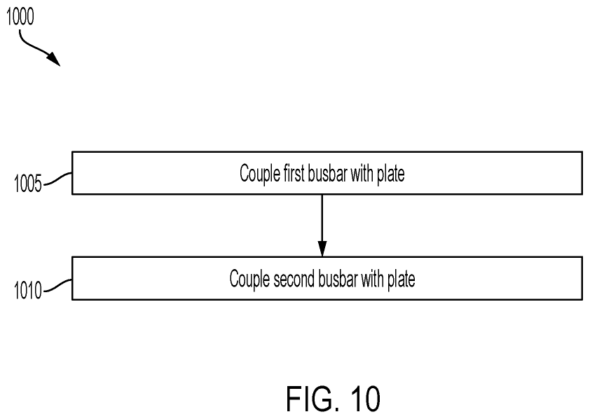

FIG. 10 depicts an example illustration of a method 1000, according to implementations. The method 1000 can include coupling the first busbar 505 with the interface member 405, as depicted in act 1005. The interface member 405 can couple with the first busbar 505 by various types of molding. For example, the interface member 405 can be overmolded onto a portion of the first busbar 505 such that the interface member 405 at least partially surrounds or encloses the first busbar 505. At least a portion of the first busbar 505 can protrude or extend from the interface member 405 (e.g., such that the first busbar 505 can couple with the first header 410 or receive the fastener 515).

The method 1000 can include coupling the second busbar 510 with the interface member 405, as depicted in act 1010. The interface member 405 can couple with the second busbar 510 by various types of molding. For example, the interface member 405 can be overmolded onto a portion of the second busbar 510 such that the interface member 405 at least partially surrounds or encloses the second busbar 510. At least a portion of the second busbar 510 can protrude or extend from the interface member 405 (e.g., such that the second busbar 510 can couple with the second header 410 or receive the fastener 520).

The interface member 405 can be or can include one interface that at least partially houses both the first busbar 505 and the second busbar 510 to reduce parts required to connect the busbars to the battery pack 110. For example, the first busbar 505 can include a unitary negative busbar that extends throughout the overmolded interface member 405 at least partially within a first header 410 (e.g., a front drive unit header 410), at least partially within the second header 410 (e.g., a rear drive unit header 410), and at least partially internally within the battery pack housing 205 to couple with a fastener 515. The second busbar 510 can include a unitary positive busbar that extends throughout the overmolded interface member 405 at least partially within a first header 410 (e.g., a front drive unit header 410), at least partially within the second header 410 (e.g., a rear drive unit header 410), and at least partially internally within the battery pack housing 205 to couple with a fastener 520.

The interface member 405 can split the first busbar 505 and the second busbar 510 into two “Y” or “U” shaped features within the interface member 405. For example, the first busbar 505 and the second busbar 510 can form generally “U” shapes that oppose and partially interface one another such that the first busbar 505 can extend from the first header 410 to the second header 410 and the second busbar 510 can extend from the first header 410 to the second header 410 while keeping the first busbar 505 separate from or insulated the second busbar 510.

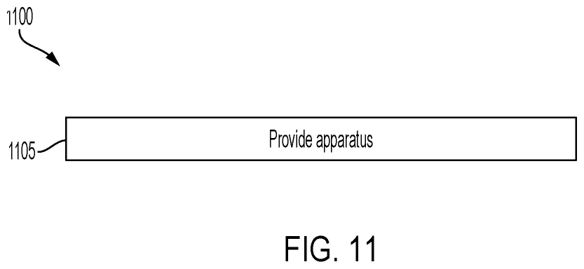

FIG. 11 depicts an example illustration of a method 1100, according to implementations. The method 1000 can include providing the apparatus 400, as depicted in act 1105. The apparatus 400 can include the interface member 405. The interface member 405 can be or can include a piece of material that couples with or joins a first header 410 and a second header 410. The interface member 405 can be an insulator. For example, the interface member 405 can be formed of one or more insulative materials including, but not limited to, plastic. The interface member 405 can be unitary (e.g., continuous, monolithic). The interface member 405 can couple with the first header 410 and the second header 410 such that the first header 410 and the second header 410 are rigidly fixed relative to one another (e.g., such that the headers 410 and the interface member 405 are all connected).

The interface member 405 can couple with the first busbar 505 and with the second busbar 510. The first busbar 505 and the second busbar 510 can be independent of one another (e.g., two separately formed busbars). For example, the first busbar 505 can be a negative connection busbar and the second busbar 510 can be a positive connection busbar.

The interface member 405 can couple with the first busbar 505 and the second busbar 510 in various ways. For example, as depicted in at least FIG. 7, the interface member 405 can be overmolded onto a portion of the first busbar 505 or a portion of the second busbar 510 such that the interface member 405 at least partially surrounds or encloses the first busbar 505 and the second busbar 510. At least a portion of the first busbar 505 can protrude or extend from the interface member 405 (e.g., such that the first busbar 505 can couple with the first header 410 or receive the fastener 515) and at least a portion of the second busbar 510 can protrude or extend from the interface member 405 (e.g., such that the second busbar 510 can couple with the second header 410 or receive the fastener 520).

The first busbar 505 can include or can be a negative busbar for a front drive unit and a rear drive unit of the vehicle 105. In other words, the first busbar 505 can be one, unitary negative busbar that connects with both the front drive unit header 410 and the rear drive unit header 410. The second busbar 510 can include or can be a positive busbar for a front drive unit and a rear drive unit of the vehicle 105. In other words, the second busbar 510 can be one, unitary positive busbar that connects with both the front drive unit header 410 and the rear drive unit header 410. With this configuration, the apparatus 400 improves conventional technology in that one unitary interface (e.g., the interface member 405) can include one negative busbar 505 and one positive busbar 510 for each of the front drive unit electrical connections and the rear drive unit electrical connections as opposed to having four individual busbars (e.g., a positive and negative busbar for only the front drive unit and a positive and negative busbar for only the rear drive unit). This overmolded interface facilitates reducing part count by combining the busbars into one interface and improves tolerance stacks by fixing the location of the multiple headers 410 relative to one another.

The interface member 405 can split the first busbar 505 and the second busbar 510 into two “Y” or “U” shaped features within the interface member 405. For example, the first busbar 505 and the second busbar 510 can form generally “U” shapes that oppose and partially interface one another such that the first busbar 505 can extend from the first header 410 to the second header 410 and the second busbar 510 can extend from the first header 410 to the second header 410 while keeping the first busbar 505 separate from or insulated the second busbar 510.

At least a portion of the first busbar 505 can receive the first fastener 515 to connect the first busbar 505 to the battery pack 110 (e.g., with a high-voltage distribution box (HVDB)). At least a portion of the second busbar 510 can receive the second fastener 520 to connect the second busbar 510 to the battery pack 110 (e.g., with the HVDB). With this configuration, the apparatus 400 improves conventional technology in that one interface (e.g., interface member 405) can couple one negative busbar 505 and one positive busbar 510 for each of the front drive unit electrical connections and the rear drive unit electrical connections with two respective fasteners 515, 520 as opposed to having more than two fasteners. Thus, providing an interface (e.g., interface member 405) that couples with multiple headers 410 enables two busbar connections as opposed to four (e.g., one fastener for a positive busbar of the front drive unit, one fastener for a negative busbar of the front drive unit, one fastener for a positive busbar of the rear drive unit, and one fastener for a negative busbar of the rear drive unit).

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

For example, descriptions of positive and negative electrical characteristics may be reversed. For example, the positioning of the first busbar 505 and the second busbar 510 can be reversed. Elements described as negative elements can instead be configured as positive elements and elements described as positive elements can instead by configured as negative elements. For example, elements described as having first polarity can instead have a second polarity, and elements described as having a second polarity can instead have a first polarity. Further relative parallel, perpendicular, vertical or other positioning or orientation descriptions include variations within +/−10% or +/−10 degrees of pure vertical, parallel or perpendicular positioning. References to “approximately,” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

What is claimed is:

1. An apparatus, comprising:
an interface member to couple with a first busbar of a first header of a battery pack; and
the interface member to couple with a second busbar of a second header of the battery pack.

2. The apparatus of claim 1, comprising:
a portion of the first busbar to receive a first fastener;
a portion of the second busbar to receive a second fastener;
the first busbar comprising a negative busbar for a front drive unit and a rear drive unit of a vehicle; and
the second busbar comprising a positive busbar for the front drive unit and the rear drive unit of the vehicle.

3. The apparatus of claim 1, comprising:
the interface member comprising an insulative material overmolded onto a portion of the first busbar and a portion of the second busbar.

4. The apparatus of claim 1, comprising:
the interface member at least partially encloses the first busbar and the second busbar;
the first busbar forms a first shape within the interface member;
the second busbar forms a second shape within the interface member; and
the first shape opposing and interfacing with the second shape.

5. The apparatus of claim 1, comprising:
the interface member comprising at least one rib to prevent rotation of the interface member relative to the battery pack.

6. The apparatus of claim 1, comprising:
the interface member comprising at least one opening that exposes one of the first busbar or the second busbar to an exterior of the interface member.

7. The apparatus of claim 1, comprising:
at least one first clip to couple a first grounding wire with the first busbar; and
at least one second clip to couple a second grounding wire with the second busbar.

8. The apparatus of claim 1, comprising:
the first busbar and the second busbar to electrically couple with the battery pack by a grounding wire.

9. An electric vehicle, comprising:
an interface member to couple with a first busbar of a first header of a battery pack; and
the interface member to couple with a second busbar of a second header of the battery pack.

10. The electric vehicle of claim 9, comprising:
a portion of the first busbar to receive a first fastener;
a portion of the second busbar to receive a second fastener;
the first busbar comprising a negative busbar for a front drive unit and a rear drive unit of the electric vehicle; and
the second busbar comprising a positive busbar for the front drive unit and the rear drive unit of the electric vehicle.

11. The electric vehicle of claim 9, comprising:
the interface member comprising an insulative material overmolded onto a portion of the first busbar and a portion of the second busbar.

12. The electric vehicle of claim 9, comprising:
the interface member at least partially encloses the first busbar and the second busbar;
the first busbar forms a first shape within the interface member;
the second busbar forms a second shape within the interface member; and
the first shape opposing and interfacing with the second shape.

13. The electric vehicle of claim 9, comprising:
the interface member comprising at least one rib to prevent rotation of the interface member relative to the battery pack.

14. The electric vehicle of claim 9, comprising:
the interface member comprising at least one opening that exposes one of the first busbar or the second busbar to an exterior of the interface member.

15. The electric vehicle of claim 9, comprising:
at least one first clip to couple a first grounding wire with the first busbar; and
at least one second clip to couple a second grounding wire with the second busbar.

16. A method, comprising:
coupling a first busbar of a first header of a battery pack with an interface member; and
coupling a second busbar of a second header of the battery pack with the interface member.

17. The method of claim 16, comprising:
a portion of the first busbar to receive a first fastener;
a portion of the second busbar to receive a second fastener;
the first busbar comprising a negative busbar for a front drive unit and a rear drive unit of a vehicle; and
the second busbar comprising a positive busbar for the front drive unit and the rear drive unit of the vehicle.

18. The method of claim 16, comprising:
the interface member comprising an insulative material overmolded onto a portion of the first busbar and a portion of the second busbar.

19. The method of claim 16, comprising:
the interface member at least partially encloses the first busbar and the second busbar;
the first busbar forms a first shape within the interface member;
the second busbar forms a second shape within the interface member; and
the first shape opposing and interfacing with the second shape.

20. The method of claim 16, comprising:
the interface member comprising at least one rib to prevent rotation of the interface member relative to the battery pack.
